(19) United States
(12) Patent Application Publication
(10) Pub. No.: US 2026/0359422 A1
(43) Pub. Date: Nov. 12, 2026

(54) Inherently Secure Computer Operating System

(71) Applicant: Steve Aokalani, Washington, DC (US)

(72) Inventor: Steve Aokalani, Washington, DC (US)

(21) Appl. No.: 19/202,067

(22) Filed: May 8, 2025

(51) Int. Cl. G06F 21/53; G06F 21/57; G06F 21/64

(52) U.S. Cl. CPC G06F 21/53; G06F 21/575; G06F 21/64

(57) ABSTRACT

According to certain general aspects, the present embodiments relate to a secure computer Operating System (OS) ecosystem in which a computer is capable of operating with complete immutability through, in part, the implementation of virtualization sandboxing. According to certain additional aspects, this OS ecosystem is unique in that new, also immutable, applications can be added while the computer is running existing applications, through a connection with a Software Hub (SH) server. According to certain additional aspects, this OS enables full immutable operation at all times and yet provides heretofore unachievable flexibility for general purpose computing.

### ORIGIN OF THE INVENTION

This invention evolved over time as the author took a class in cybersecurity. The author approached cyber security from a different perspective than many, having had roles involving detailed interaction with end-use customers of enterprise software rather than as a software developer. This perspective enabled the author to ask questions of all the key assumptions that go into modern computing systems design, coming from outside the traditional software developers' world. Each new module of the class detailed another aspect of how Threat Actors (TAs) perpetrate cyber crime. And each time the author learned another aspect of how TA's do their work, the same question came up: "It can't really be this easy to compromise computers, can it?", and each time the answer was "yes, it really is that easy". And then the next question was always, "why do they do it this way if it allows TA's to break the system?" Each module of the class was work related to another link in the kill chain, so to speak, or another step in a series of steps required for a TA to complete a successful compromise of a system or systems. Very sophisticated attacks, such as was done to Microsoft with the Chinese Salt Typhoon attack, involve many steps and yes, sometimes some brilliance on the part of the TA, but, far more common is fairly simple exploitation of one weakness, called a vulnerability, along with standard exploitation of poor design in current OSes. What the author noticed each time is that it's that easy because computer operating systems (OSes) in current use evolved from the perspective of making computers more valuable by making them universal and general purpose. What made computers become embraced in business is the ability to add new software to empower employees to do their job better, faster, and with less resources. A vast ecosystem of software application vendors evolved into the modern software industry. It became an assumed characteristic of general purpose computers that users have to be able to add software. But that ability also means that TA's can trick a user into adding malware, or they can trick a user into giving them credentials to login to that user's computer, and then the TA goes to work exploiting all the poor design characteristics of modern OSes, often by installing malware, until they have the ability to reach their cyber crime goal, which may be extracting information undetected, encrypting data and getting ransome money for the keys, publishing stolen data to harm that organization's reputation, etc.

Fundamental to the problem of cyber crime spiraling out of control, as the author saw it, is the assumption that any user must be able to add software. That means if software can be added to a machine, so can malware, unfortunately. The author asked the question, if we took away this assumption, could we design a more secure system? The answer is a resounding yes, as evidenced by the attempts to get some system immutability by companies and organizations doing immutable OSes, such as IBM's Redhat Fedora SilverBlue OS, Vanilla OS, Kairos, and others. But all these organizations only implement partial immutability, as they could not let go of the idea that an end-user has to be able to add software. Could a complete immutability system be created that would still allow the computer to be general purpose and retain the ability to add applications via some other method?

Another assumption to be questioned is that computers can have multiple users. Everyone in an organization today has their own computer, so multi-user capability is really not needed. IT departments will tell us that is necessary for maintenance by them, but, is it really? What could be gained by letting this assumption go? A TA is able to compromise a system, and then, using vulnerabilities, upgrade privileges, and create a new but hidden user with full privileges. Stopping this is also very important to security, and can be seen as another aspect of full immutability - the ability to not allow any new users or user privilege changes on an OS. Can we toss out the multi-user requirement?

There are ways to add malware that avoid putting it on hard drives and thus being detectable. Is the functionality of an OS that enables loading malware into memory really needed? What is the cost of this? Big costs. Could this fileless malware be inherently stopped?

It turns out there are many shades of grey when it comes to immutability, which is broadly speaking, just the ability to operate software in a mode such that it cannot be changed. TA's have a VERY hard time doing their job if there is no aspect of a computer operating system or applications that can be changed. The more complete and comprehensively you make your system immutable, the more secure it gets. The above examples are just a few of many.

Until now there has been no viable way to have a computer be general purpose and yet comprehensively immutable. What this invention does that is new is it throws out the old assumptions of unrestricted user capabilities and makes it possible to construct an ecosystem of computers that are inherently very difficult to compromise, making use of known good methods for virtualization and immutability combined in a highly synergistic architecture. The groundbreaking aspect is, through the use of this invention, one can achieve comprehensive immutability that is effective and efficient for general purpose company or organization-wide usage by all members of the organization.

### BACKGROUND OF THE INVENTION AND PRIOR NON-PATENTED ART

Much of computer system security, as commonly practiced, focuses on 3 areas:
a. Adding security measures in the form of software applications that monitor for signs of Threat Actor (TA) intrusion and then respond to those threats;
b. IT departments are frequently being provided changes by software vendors, called patches, to the vendors' software products to fix coding errors that TA's leverage to compromise systems, which must be constantly implemented in order to stay ahead of TA's; and
c. Training of users on how to configure and operate systems more safely.

The trend is increased spending on the above-noted efforts industrywide, and yet we are experiencing accelerating total costs of cyber crime, so it is clear something more fundamental must be done to stem the growth of cyber crime. Since Operating Systems are the software foundation upon which computers run, the optimal solution to this problem is to create an OS for computers that is inherently secure. There have been several initiatives in the industry to attempt this, but none have been both successful and practical for all the users in an organization.

One approach to a more inherently secure OS involves using Immutability to restrict the damage a Threat Actor (TA) can cause when they compromise a system, or to prevent any compromise to even be started. Immutability spans a wide range of restrictions up to and including complete immutability in which users cannot be added, privileges cannot be changed, there is no admin/root super user, system files and application files cannot be altered, software cannot be installed in memory, and critical configuration files cannot be altered. There are several computer OSes in use today that offer some aspects of immutability, though none allow comprehensive immutability for general purpose use. With a fully immutable OS no software applications can be added. A system like this is used, for example, in kiosks with a single purpose application running. These systems are very secure because software cannot be installed as the system is designed for single purpose or application use. In order to have full immutability, and yet have a computer still be suitable for general use, a method must be implemented to enable adding applications as needed without dropping immutability. One such method in use today that comes close to this ideal is often called the "A/B approach" in which there are two parallel OSes running. One of the two is where work is done, the configuration of which has some degree of immutability, and the other of the two parallel OSes is the standby system that is not immutable. When an application or software is needed to be added or modified, it is done with the standby system. Then the standby system is converted to immutable and becomes the working system, and the other previously working system becomes the standby. The application or other software being added to the standby OS can come from anywhere, so the potential for malware to be added to the standby system exists. While some functionality of malware may be stopped in the conversion to immutable, not all avenues of compromise can be closed because the immutabilty trait was accomplished after the malware was installed, and because the method precludes some aspects of complete immutability.

A second approach to a more inherently secure OS is the use of virualization sandboxing which isolates the operations of applications from each other and from the Host OS. Each application, or class of applications, runs in it's own virtual machine, (VM), also called a Guest VM, and all these virtual machines run, via a virtual machine manager (VMM) to manage them, on the Host OS of the computer directly. This is one version of a Virtualization Technology System. This approach does not stop compromise of an application, but it does severely limit the damage a TA can accomplish by making further system compromise through the compromise of other applications, or the Host OS, via the already compromised VM, much more difficult. Another method of Virtualization Technology Systems is called Containers. Containers are similar to VMs, but Containers share some parts of the Host OS. Containers can be and often are implemented as partially immutable, depending on usage. For discussion of this patent's innovation, it is necessary to generalize the topic of Virtualization Technology Systems. This distinction is not common in the industry in general. Innovation in the industry to develop more types of Virtualization Technology are likely in the future.

A third approach to inherently more secure computing is to build a new OS from the ground up, designed to be more secure. One very promising approach is the use of very small OSes called MicroKernels. Anything that can be removed from the kernel and run in userspace is offloaded from the kernel, including, especially, drivers that are commonly an avenue for compromise. This approach is inherently secure because the attack surface is minimized, but, it requires all applications, (e.g. Word, Excel, Autocad, et al), to be written from scratch to the new OS. While this is working well for very high security, high reliability systems such as aircraft flight control systems, the costs to write all needed applications for general purpose computing to a new OS is an insurmountable one for commercial or everyday computer use.

A fourth approach to inherently more secure computing is indicated in US patent US11132437B2, which details disabling the execution of binary format software. This method would contribute substantially to improved security, however, most if not all application vendors would be unwilling to distribute their software as source code because that would enable very easy theft of their intellectual property. This makes use of this method very restricted in scope. The key relevant point is that disabling the primary format of malware distribution, binary loading, would be a very big win for secure systems, so it is included in this discussion because it is a good segue to the method proposed herein. Preventing any kind of code execution, friendly or otherwise, source or binary or otherwise, is an essential element to combating cyber crime with inherently more secure systems.

### SUMMARY OF THE INVENTION

According to certain general aspects, the present embodiments relate to a secure computer Operating System (OS) ecosystem in which a computer is capable of operating with complete or comprehensive immutability through, in part, the implementation of virtualization sandboxing. According to certain additional aspects, this OS ecosystem is unique in that new, also immutable, applications can be added while the computer is running existing applications, through a connection with a Software Hub (SH) server. According to certain additional aspects, this OS enables full immutable operation at all times and yet provides heretofore unachievable flexibility for general purpose computing.

### OBJECT OF THE INVENTION

Computer operating systems. More specifically, computer operating systems that are inherently secure against cyber crime.

### PRIOR ART PATENT FILINGS

The following list of filings is in no particular order of importance or relevance to the invention of this filing.

US11010475B1 MAY 18, 2021 JANUS TECH INC US
a. "According to certain general aspects, the present embodiments relate to providing a secure computer architecture in which a single computer is capable of simultaneously executing two operating systems. According to certain additional aspects, the two operating systems can have different security profiles and capabilities. According to still further aspects, the secure computer architecture further provides secure video conferencing capabilities, network activity monitoring and high performance computer graphics."
b. Comments: this patent is designed to provide a more secure architecture mainly for video conferencing. Similar to A/B type immutable OSes, but makes no mention of immutability. The primary objective of this invention is making the boot method more secure, but, there is no inherent security to prevent malware introduction to a running machine.

US2007192854A1 METHOD FOR PREVENTING MALICIOUS SOFTWARE INSTALLATION ON AN INTERNET-CONNECTED COMPUTER
a. Utilizes two separate OSes running simultaneously, but makes no mention of Virtualization Technology System to enable it. Utilizes partial immutability in secondary internet-only OS in which malware cannot, in some instances but not all, be installed from browser, (does not call it immutability). Because they get specific on one aspect of immutability, it is therefore incumbent upon them to mention all necessary aspects of complete immutability, and they do not, so their approach, done exactly as they say, would leave many avenues for a TA to attack the Internet OS system. Special browser, email client, and OS written specifically for this purpose. Focuses on internet-facing threats, which are not all possible threats.
b. Makes no mention of how two partitions are created and managed that is based on established methods of known VTS approaches. The word Partition normally refers to completely separate regions of memory that, normally, are separately booted into. It is not standard procedure for an OS and hardware to be able to switch between separate partitions and run both simultaneously, so it is inferred here that the system envisioned must be created from the ground up, and thus extremely costly. Specifically names CRC authentication of files throughout, but many methods are better than this, such as hashing.
c. Authors were on the right track regarding stopping malware from internet, but they do not use industry standard practice methods for virtualization sandboxing to provide sufficient isolation of the two OSes, they leave the standard OS open to compromise, and they do not seem to understand the depth required for complete immutability such that the Internet OS would be secure against modern threats.
d. IBM, the owner, certainly has the resources to create this invention, but, if they were to do so today, they would almost certainly take a completely different approach based on established state of the art, such as microkernels. Either way, all applications for a custom OS such as this would need to be written from scratch for that OS, which is insurmountably costly for most application vendors to be willing to do to engage in this ecosystem.
e. Summary relative to currently proposed invention:
   i. no mention of VTS;
   ii. not full immutability;
   iii. fully custom OS cannot use common applications and common OSes;
   iv. does not utilize separate server to provide known good software applications in immutable form.

SECURE COMPUTER OPERATING SYSTEM THROUGH INTERPRETED USER APPLICATIONS US11132437B2
a. OS that does not allow execution of any software in binary form.
b. Great idea in terms of severely limiting ability of TA's to install malware.
c. No existing application will run on this OS, as no vendor will be willing to distribute their application as source code because they cannot protect their intellectual property.
d. Not similar to present invention except for the objective of limiting how any software, and thus also malware, can run on an OS.

METHOD OF SECURE DATA PROCESSING ON A COMPUTER SYSTEM US2008178290A1
a. This works on the idea of having a separate process that manages the authentication of other files and systems visible to the user. US2008178290A1 utilizes a VM to oversee and monitor the actions of another VM. It proposes a poor method of accomplishing this with a broken VTS. Oversight could be better accomplished by the Host OS, or by nesting VMs. Normally it would not be accomplished by allowing one VM a kind of super user access to another, as VM technology in common use is designed specifically to avoid this.
b. US2008178290A1 makes no use of immutability, nor of a server ecosystem, and is thus not close to present invention.

US10055245B1 IMMUTABLE CONFIGURATION OF VIRTUAL COMPUTER SYSTEMS
a. The problem this patent solves is the management of hyperscaler activities associated with scale and security through the creation of a management system to manage immutability requests associated with virtual machines. It would seem obvious that such a system would be needed and that each hyperscaler would obviously need to implement some kind of system like this, yet no mention is made of what is really innovative, so it's hard to see how this is unique and patentable.
b. What is interesting about this patent is that it discusses immutability, virtual machines, and security. But the context is the solving of a completely different problem than the present invention, so it's not close prior art.

### DESCRIPTION OF DRAWINGS

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a diagram illustrating the full invention ecosystem;

FIG. 2 is a diagram illustrating greater detail on Virtual Technology System Packages of this invention;

FIG. 3 is a diagram illustrating a flow chart of the "adding an application to the computer" process.

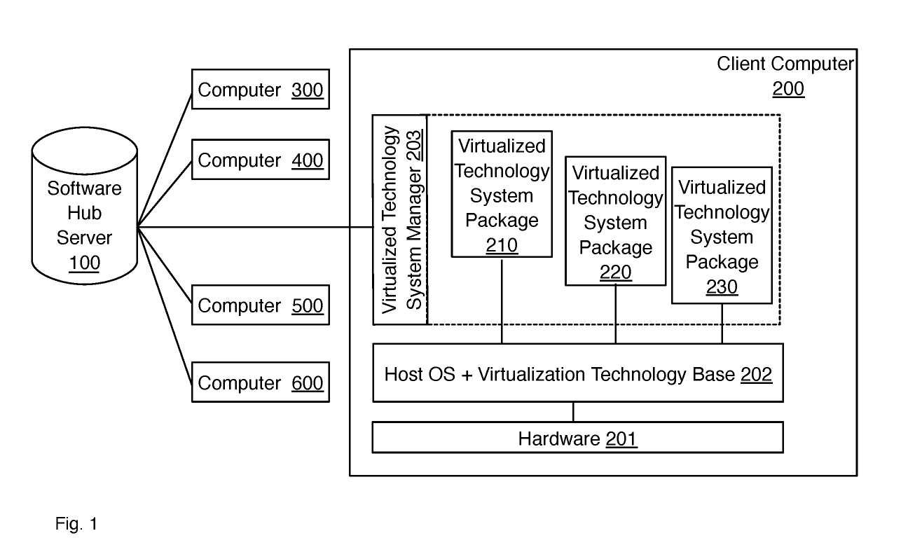

FIG. 1 Shows the overall architecture. A Client Computer (200) with base hardware (201) is configured with a Host OS and Virtualization Technology Base (202), (for example, an embodiment could be a Hypervisor), that enables the creation of one or more Virtualization Technology System (VTS) Packages, (for example, an embodiment could be virtual machines (VM)), (210, 220, 230, ...). This drawing is meant to be generic as to the exact relationship of Host OS and VTS since there are many choices of VTS that will work with this invention, any one of which would be drawn somewhat differently in terms of it being a part of the Kernel, in userspace, or some combination or hybrid thereof. The VTS Manager (203) creates, configures, maintains, starts and stops, and deletes VTS Packages. The VTS Manager is configured to communicate externally only with one or more Software Hub (SH) Servers (100), so the SH Server is the only place from which the VTS Manager can obtain new software. Each VTS Package can communicate with virtualized hardware devices included as Hardware (201), such as printers, network interfaces, and others in an industry standard manner. A Software Hub Server (100) communicates with one or more computers, (200, 300, 400, 500, 600, ...).

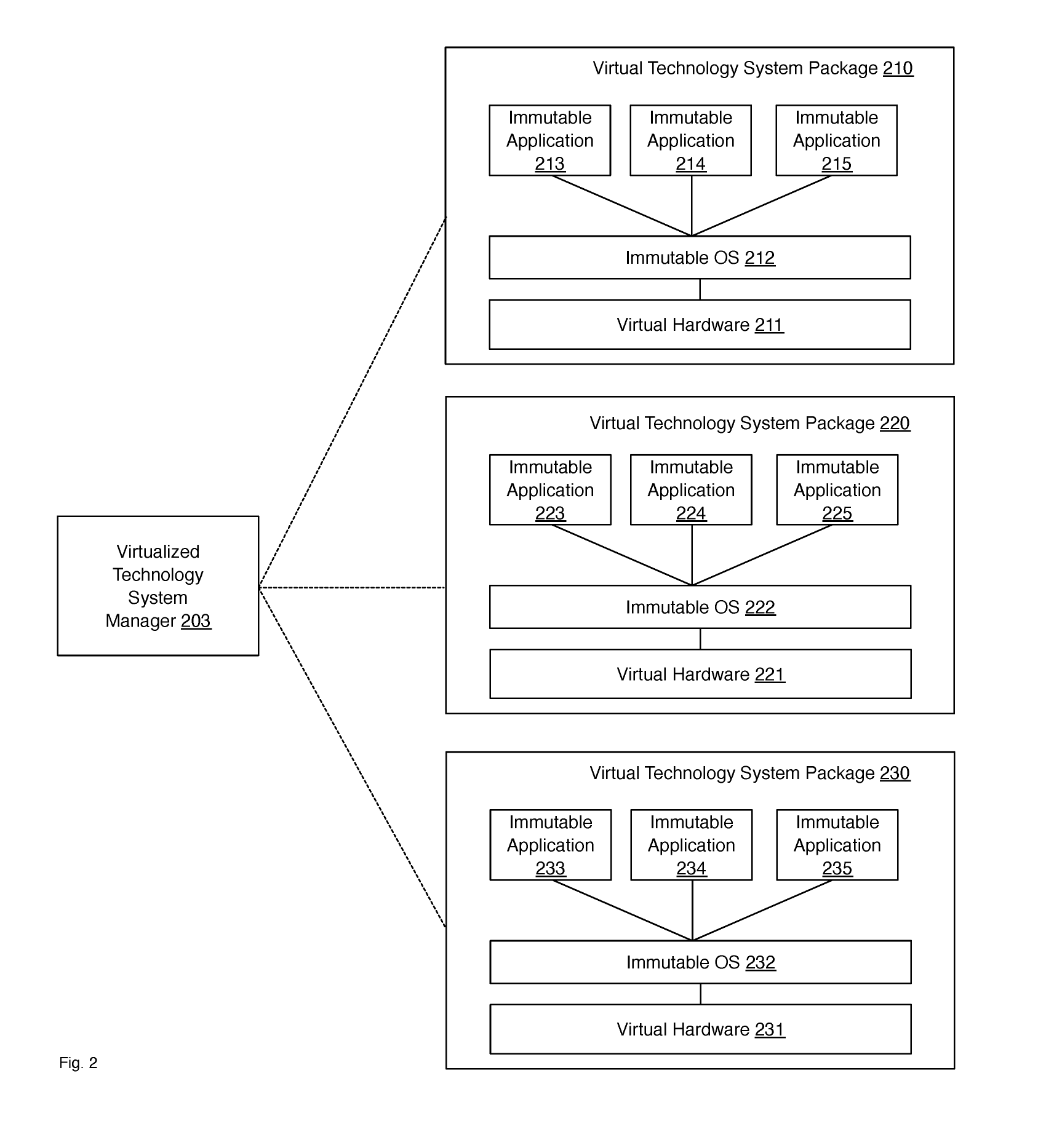

FIG. 2 Shows more detail on VTS Packages (210, 220, 230, ...) and the subsystem to manage them, the VTS Manager (203). From the perspective of the OS above, (212, 222, 232, ...), the Virtual Hardware (211, 221, 231, ...) appears as if it is an actual physical machine. Applications (213, 214, 215, ..., 223, 224, 225, ...) are installed on the OS of the VTS Package. VTS packages are created in a separate process independent of the user of the computer, for example by the IT department, where an OS along with an installed Application or Applications is assembled, then made immutable and then saved as an image on the SH Server for a client computer to download as desired by the user.

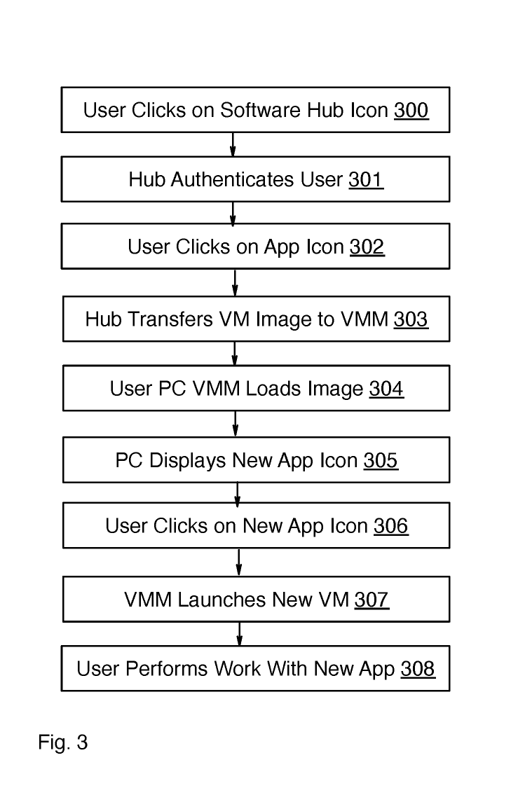

FIG. 3 Shows a typical flow for adding an application to an already running client computer with the OS ecosystem of this invention. The User has an icon on their client computer desktop that represents the SH server. User clicks the SH server icon (900), and the client computer then connects to the SH server and gets authenticated (901). The client computer displays an interface showing available applications approved for that user, and the user clicks on an icon for an application the user will be using, (902). The SH server transfers the selected VTS Package image to the VTS Manager (903), which receives the file and loads it (904) and adds an icon for that app to the client computer user's desktop (905). When the user is ready to work in the new app, they click the new icon on their desktop (906) and the VTS Manager starts the app (907), and the user may now perform work with the new app (908).

### BEST MODE FOR CARRYING OUT THE INVENTION

This invention is a computing environment architecture which has never been available before, and for which there are very substantial benefits in terms of security against the perpetration of cyber crime on users. This invention is an architecture, not a specific software. It has been found in the author's research on this that there are many implementation variations that can be utilized in the implementation of this architecture, but the essential elements of the invention are clear and actually fairly simple for those skilled in the art to understand. Those skilled in the art would find most of the choices in implementation to be obvious as to which choice provides the best improvements to security, but some, such as a choice between using Virtual Machines technology or Container technology, can reasonably be argued by those skilled in the field to be less obvious as to which is better from a usability or security posture perspective. For these reasons, a "best mode" involving specific software element choices would be speculative and likely to evolve over time.

The architecture of this invention makes it possible to operate a computer with complete immutability and yet with the flexibility computers for general use are expected to provide. As long as this complete immutability is not circumvented by a bad choice of a particular software package to build the system, then the system will be inherently far more secure than current OSes. The best mode is therefore not especially specific in terms of software packages to use, but it is clear the following elements are essential to the architecture of this innovation:
a. client computers run as immutable and use a Virtual Technology System (VTS) which is only able to add an application through the downloading of immutable VTS package images;
b. a Software Hub (SH) server or servers provide the sole point from which these images can be downloaded;
c. software runs on clients and SH server to ensure this architecture and configuration are the only allowed architecture and configuration;
d. application packages must be created which do not circumvent this immutability;
e. and implemented such that no software of any kind can be installed, added, or in any way implemented on the VTS packages or the base or Host OS, other than through immutable images from the SH server.

### DETAILED DESCRIPTION OF THE INVENTION

Features and advantages of the present disclosure will become more apparent from the detailed description set forth below when taken in conjunction with the drawings.

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and processes have not been described in detail to avoid unnecessarily obscuring aspects of the disclosure.

In order to generalize on key aspects of this invention we will use the term Virtual Technology System (VTS), which is sometimes used in the IT industry but not universally understood. A VTS is a system for operating software in compartments or packages that are isolated from each other and generally not allowed to communicate with each other. Thus software in one compartment or package has no ability to inspect or change files in another. This is a valuable property that improves security posture. VTS are used to improve security posture because if one compartment's application software cannot be aware of or communicate with any other compartment then compromise by a Threat Actor (TA) of one application package does not enable a TA to compromise all applications and their data nor the underlying Host OS. This is often referred to as virtualization sandboxing in the industy. The two most common VTS approaches in use are Virtual Machines (VM), and Containers. It is possible and indeed likely that more methods to fully isolate one software package from another may be invented in the future and could be applied to this inventions' approach for securing an Operating System.

A Software Hub (SH) server (100) is configured in a one to many relationship, in standard IT methodology, with multiple client computers. Common to standard industry practice, noting a "server" as a single entity my actually refer to a multitude of servers in cloud configuration that work in concert to appear to the client computer as a single server. Herein, references to a single server can optionally include this type of cloud configuration, or, just a single physical server. All software that is allowed to run on a client is provided solely by the SH server. Client software is configured to only allow VTS package images to be added, and they can only come from that client's SH server. It is likely that the SH server will be configured to provide additional services to the clients, but, for the purposes of this invention, further services provided by the SH server are not material to the uniqueness of the invention.

Embodiments of the present disclosure provide systems, methods, and devices for the use of a computer operating system with immutability and yet with a degree of usability not previously attainable as a general computing platform. What is unique and new is the use of a VTS to enable comprehensive immutability to be implemented while still allowing the user to add applications to their device at a time of their choosing, and also, importantly, while the computer continues to run other applications. No downtime is needed to add or remove software to the client computer. Until this invention, there has been no known method to accomplish comprehensive immutability while retaining general purpose use. A client (200, 300, 400, 500, 600, ...) can only add applications through downloading of an immutable VTS image from the SH server. There are three key elements to this invention: 1) virtualization sandboxing; to enable 2) immutability; via an 3) SH server. This innovation cannot be described without these three elements.

The first essential aspect of this invention is the use of virtualization technologies that include, for example, but are not limited to, virtual machines (VMs), Containers, some combination of the two, or other VTSes. Implementations of VMs and Containers are different in the details, but each is a viable standard industry practice method of implementing a VTS such as is necessary to implement this invention. It is standard industry practice to utilize images to create new VTS packages. Packages can also be built from the ground up using OS code by using the VTS Manager, also according to standard industry practice, but, that method of creating a package must be disabled for this invention. Standard practice with VTSes is to download an image with the VTS Manager and then that image can be launched immediately. Utilizing a VTS enables this invention and is essential to the design, because this is a universal method of distributing software that can easily be made highly secure, and the format of distributed software can be locked in to one and only one method such that file corruption and hijacking is extremely hard for a TA to accomplish, and even if they did, the client computer will be able to detect it and not allow the application package to run. The VTS enables a running client computer to add an application, with little to no downtime for other applications currently running on the client computer, such that that new package is entirely immutable.

The second essential aspect of this invention is immutability, a concept that is well understood in the industry to improve security posture. It is the setting of file attributes and other steps such that files cannot be changed or created or destroyed - including files in active memory and files on discs. A strict or complete implementation of immutability does not allow any software installation of any kind on the computer and represents the ultimate security paradigm. For this invention it is important to clarify that software installation is a very different set of processes from the method of adding VM images utilized herein. A software install cannot be performed on this system, either on the Host OS (202) or on any VTS package OS (212, 222, 234, ...), but, applications can be added through the addition of a VM image via the VTS Manager (203) managed process. Therefore, malware also cannot be installed by a TA nor accidentally by the user. The only method of adding software is via the VTS Manager and SH server process of downloading VTS package images that are constructed to be fully immutable. Immutability is never lost and the computer hardware is never required to be shut off or rebooted.

Even if by some compromise or weakness of an implementation of this design, perhaps possibly due to an error, some software or malware was installed, the immutable properties of the Host or the OS and application package will not allow the malware to function per its design. The use of this full immutability is the obvious most secure posture to those skilled in the art, but, prior to this invention it has not been demonstrated that a fully immutable system can also allow a user to add an application as needed. Some systems on the market use immutability but they have not been able to deploy comprehensive immutability. Specialized systems, for example routers or self-service kiosks or airplane control systems, can be implemented with substantially immutable properties. But general purpose computing vendors make the assumption that the ability of a user to add software is fundamental to the PC design, and thus no vendor has thought of the solution of this invention.

The third essential aspect of this invention is the Software Hub (100). This is a server that runs software to enable: 1) downloading of approved VTS package images upon client request; 2) pushing of VTS package images to clients; and 3) the deletion of VTS package images in a process controlled by a central authority such as an IT department.

The properties of the package images that are presented for users to download are that they are immutable VTS package images of typically single applications or collections of applications on an OS. The Host OS (202) and VTS Base allows these VTS package OSes to be any OS an Application requires. This makes it possible for most existing applications to run on this new secure OS system. The VTS package images are created and tested and then immediately prior to posting on the server they are converted to complete immutability through standard industry methods and processes.

### CONCLUSION

Full and complete immutability is the ideal secure system posture for any IT system. This is, by definition, an application or system that cannot be changed. Users sometimes need to make changes, such as adding an application or updating software. But enabling users to make changes therefore enables Threat Actors (TA) to do the same or trick the user into doing so to support TA actions. This invention is the first architecture for general purpose computing whereby TAs can be stopped and yet users can still add new capabilities to their computer that can come from the vast array of software applications on the market. There must be a Software Hub (100) server, and thus there must be an organization that maintains that server. So in a sense we have made a tradeoff decision that to be inherently secure, a computer cannot function as a standalone computer that does not at least sometimes have to connect with a server. However, it must be made clear that the computer with this OS is secure on it's own. It just needs the Software Hub whenever a new application is needed, and it must be required to check in with that server on an IT-determined periodicity so that any package can be deleted by the SH server if that user is no longer allowed to have access to that application or it's data.

Virtualization enables a far superior method of implementing truly strict or comprehensive immutability. And virtualization is also, in and of itself, an industry-recognized method to improve security posture. Each VTS package, even if it is compromised, will still not allow a TA to easily pivot to other applications and data.

There is ideal design of software and then there is practical implementation. Implementation must be done by real humans that can sometimes make mistakes. Traditionally those mistakes can and often do result in weaknesses in software that can be exploited by TAs to compromise a system. These mistakes, or coding areas, are commonly referred to as vulnerabilities. This is all to say that it has been, up until now, extremely difficult to get to low probability of compromise. Modern systems run on as many as 50,000,000 lines of code within which it is basically impossible to attain zero exploitable errors.

When a TA accomplishes a compromise, there are many steps required to fully accomplish the end goals. One vulnerability should not, in and of itself, be enough for a successful compromise. But there are actually a number of properties of existing systems that, were they designed for the modern threat environment, would not be allowed. These properties allow a TA to accomplish the many steps, often called a kill chain, required to be successful in their attack. The new "vulnerability" that is discovered and allows an attack, and the many other poor current design properties of computer OSes are realistically a collection of vulnerabilities, not just one. Most of the collection are inherent to the design and in most cases not realistically fixable without the type of complete redesign afforded by the current invention through the use of its new set of assumptions.

With this invention, because of it's full immutability and it's virtualization isolation, effective compromise is extremely difficult to accomplish because all the steps of most kill chains are stopped or made far more difficult for TA's to exploit. Thus the discovery of the existence of a new zero day vulnerability coding error somewhere in the software as implemented, is still, with this system, not going to be enough for a TA to accomplish their goals. This has far reaching impact. The way vulnerability-based security methods work today is the software vendor, (the OS vendor or the application vendor, or both), is notified or finds by themselves a vulnerability and patches the system to fix the error and then issues a notice for operators to install this patch and makes it available for download. This means that all IT departments have an immediate urgency to patch their systems of this new vulnerability, especially if it is rated as Severe by the vendor. But with the OS of this invention and it's disabled kill chain elements, the newly discovered vulnerability does not present danger of compromise. With the use of this invention, an IT system operator does not do frequent patching of vast numbers of OS systems and their applications. The operator is therefore gaining a substantial savings in maintenance and operating costs along with the fundamental improvement in security posture and system uptime.

1. An inherently secure computer Operating System (OS) ecosystem comprising a Software Hub (SH) server and one or more client computers configured such that:
a. applications on a client are mutually isolated software units, which we generically define as Virtualized Technology System (VTS) packages, which may be but are not limited to Virtual Machine (VM) and/or Container technology;
b. the only source of new applications or software for a client computer is VTS package images from the SH server, which are an OS combined with one or more applications or software, all of which is immutable;
c. the client hardware level OS is run immutable with the sole exception being the ability to add VTS package images.

2. The system of claim 1, the SH Server of which comprises:
a. a physical or a virtual cloud-based technology server implementation;
b. software running on it that enables it to initiate, or, enables responding to a client computer request to initiate an action to add or delete a VTS package from the client;
c. user defined periodicity of SH to client communication establishment, enabling full client application functionality without real-time connection to the server at all times;
d. resident software that enables and enforces this as the sole configuration and policy.

3. The system of claim 1, further comprising client computers each comprising:
a. a computer hardware system;
b. a Host computer OS and a Virtualization Technology System including a VTS Manager that enables the use of Virtualization Technology packages for all user applications on that client;
c. this Host OS and Virtualization Technology System further comprises being run as immutable with the only exception being the ability to add or delete VTS packages;
d. VTS packages can only be added to the client computer as as a result of the client sending a request to the SH server, or by an SH server push;
e. resident software on the client that enables and enforces this as the sole configuration and policy.

4. A method of establishing a secure computing environment for users utilizing a Software Hub (SH) server and client computers comprising:
a. client computers each running only a Host OS and Hypervisor immutably with the singular exception to that immutability being that applications can be added to the client by acquiring immutable VM images sourced from the SH Server;
b. an SH Server that is the sole source of images for clients;
c. software on the SH server and clients than enables and enforces this as the sole configuration and policy.

5. A method of establishing a secure computing environment for users utilizing a Software Hub (SH) server and client computers comprising:
a. client computers each running only an OS and Container system immutably with the singular exception to that immutability being that applications can be added to the client by acquiring immutable Container images sourced from the SH Server;
b. an SH Server that provides Container images to clients;
c. software on the SH server and clients than enables and enforces this as the sole configuration and policy.

6. A method of establishing a secure computing environment for users utilizing a Software Hub (SH) server and client computers comprising:
a. client computers each running only a Host OS and Hypervisor along with a Container System, all immutably, with the singular exception to that immutability being that applications can be added to the client by acquiring immutable VM or Container images sourced from the SH Server;
b. an SH Server that provides images to clients;
c. software on the SH server and clients than enables and enforces this as the sole configuration and policy.

7. A method of establishing a secure computing environment for users utilizing a Software Hub (SH) server and client computers comprising:
a. client computers each running only a Virtualized Technology System (VTS) immutably with the singular exception to that immutability being that applications can be added to the client by acquiring immutable VTS package images sourced from the SH Server;
b. an SH Server that provides images to clients;
c. software on the SH server and clients than enables and enforces this as the sole configuration and policy.
